(19) United States
(12) Patent Application Publication
(10) Pub. No.: US 2017/0115859 A1
(43) Pub. Date: Apr. 27, 2017

(54) MONITORING SYSTEM AND CONTROL METHOD THEREOF

(71) Applicant: DYNACOLOR INC., Taipei (TW)

(72) Inventors: Cheng-Han Huang, Taipei (TW); Tsung-Tse Lee, Taipei (TW)

(21) Appl. No.: 14/918,942

(22) Filed: Oct. 21, 2015

(51) Int. Cl. G06F 3/0484

(52) U.S. Cl. CPC G06F 3/04845; G06F 2203/04803

(57) ABSTRACT

A monitoring system may include a display module, an input module, and a processing module. The display module may be operable to display a plurality of sub-windows. The input module may be operable to receive an input signal inputted by a user and generate a control signal according to the input signal. The processing module may be operable to receive the control signal to control any one of the sub-windows of the display module according to the control signal. When the coverage of any one of the sub-windows is modified by the user, the processing module will execute a first recursive function to detect whether the modified sub-window overlaps any one of the other sub-windows; if the modified sub-window overlaps any one of the other sub-windows, the processing module pushes the sub-window overlapping the modified sub-window to a residual space of the display module.

### BACKGROUND OF THE INVENTION

1. Field of the Invention

The present invention generally relates to a monitoring system, in particular to a monitoring system with multiple functions. The present invention further relates to the control method of the monitoring system.

2. Description of the Related Art

Nowadays, as people pay more attention to their security and safety, monitoring system has become a very important device for everyone. However, the conventional monitoring system has a lot of shortcomings to be overcome.

For example, if a user wants to see more details of one of the sub-windows of the conventional monitoring system, the user should enlarge this sub-window. However, after the sub-window is enlarged, the other sub-windows may be covered by the enlarged sub-window. Thus, once one of the sub-windows is enlarged, the user cannot see all of the sub-windows; for the reason, the conventional monitoring system cannot always display all sub-windows. In this way, the user may miss some important information when some sub-windows are covered by the enlarged sub-window.

In general, the conventional monitoring system only provides several fixed modes to display the sub-windows; therefore, in most cases, the user cannot adjust the size and the position of the sub-windows at will, which is not flexible in use.

Besides, generally speaking, the conventional monitoring system is very hard to operate because the user usually needs to click various icons on the screen of the monitoring system to perform the desired functions. Thus, the conventional monitoring fails to provide a user-friendly operation interface.

Moreover, if the conventional monitoring system has two or more displays, the user usually needs to readjust the setting of the conventional monitoring system in order to allocate these sub-windows to the displays, which is very inconvenient for the user.

Therefore, it has become an important issue to provide a monitoring system capable of overcoming the problems that the conventional monitoring system cannot always display all sub-windows, is not flexible and not convenient in use, and fails to provide a user-friendly operation interface.

### SUMMARY OF THE INVENTION

Therefore, it is one of the primary objectives of the present invention to provide a monitoring system and a control method thereof to overcome the problems that the conventional monitoring system cannot achieve high security, is not flexible and convenient in use, and fails to provide a user-friendly operation interface.

To achieve the foregoing objective, one embodiment of the present invention provides a monitoring system, which may include a display module, an input module, and a processing module. The display module may be operable to display a plurality of sub-windows. The input module may be operable to receive an input signal inputted by a user and generate a control signal according to the input signal. The processing module may be operable to receive the control signal to control any one of the sub-windows of the display module according to the control signal. When the coverage of any one of the sub-windows is modified by the user, the processing module will execute a first recursive function to detect whether the modified sub-window overlaps any one of the other sub-windows; if the modified sub-window overlaps any one of the other sub-windows, the processing module pushes the sub-window overlapping the modified sub-window to a residual space of the display module.

To achieve the foregoing objective, one embodiment of the present invention further provides a control method for a monitoring system, which may include the following steps: displaying a plurality of sub-windows; modifying the coverage of one of the sub-windows; executing a first recursive function to detect whether the modified sub-window overlaps any one of the other sub-windows; and pushing the sub-window overlapping the modified sub-window if the modified sub-window overlaps any one of the other sub-windows.

The monitoring system according to the embodiments of the present invention have the following advantages:

(1) In one embodiment of the present invention, after the coverage of any one of the sub-windows is modified, such as being enlarged, minified, reshaped, or moved, the monitoring system can automatically push or pull at least one of the other sub-windows, or minify the modified sub-window to prevent these sub-window from overlapping the enlarged, minified, reshaped, or moved sub-window. Therefore, the user will never miss any important information, so the monitoring system according to the present invention can achieve higher security.

(2) In one embodiment of the present invention, the user can adjust the sub-windows of the monitoring system by an intuitive drag-and-drop operation instead of complicated operation interface. Thus, the monitoring system according to the present invention can provide a more user-friendly operation interface.

(3) In one embodiment of the present invention, the user can enlarge, minify, or reshape any one of the sub-windows at will or move any one of the sub-windows to any position of the display module. Therefore, the monitoring system according to the present invention is more flexible in use.

(4) In one embodiment of the present invention, the user can enlarge, minify, reshape, or move any one of the sub-windows only by a simple drag-and-drop operation, and then the monitoring system will automatically rearrange the other sub-windows according to the residual space of the display module. Therefore, the monitoring system according to the present invention provides a user-friendly operation interface.

(5) In one embodiment of the present invention, if the monitoring system has two or more display modules, the processing module will automatically allocate the sub-windows to all of the display modules; accordingly, the user does not need to readjust the setting of the monitoring system. Therefore, the monitoring system according to the present invention is more convenient in use.

### BRIEF DESCRIPTION OF THE DRAWINGS

The detailed structure, operating principle, and effects of the present invention will now be described in more details hereinafter with reference to the accompanying drawings that show various embodiments of the invention as follows.

FIG. 1 is the block diagram of the monitoring system in accordance with the present invention.

FIG. 2A is the first schematic view of the first embodiment of the monitoring system in accordance with the present invention.

FIG. 2B is the second schematic view of the first embodiment of the monitoring system in accordance with the present invention.

FIG. 2C is the third schematic view of the first embodiment of the monitoring system in accordance with the present invention.

FIG. 2D is the fourth schematic view of the first embodiment of the monitoring system in accordance with the present invention.

FIG. 3A is the first schematic view of the second embodiment of the monitoring system in accordance with the present invention.

FIG. 3B is the second schematic view of the second embodiment of the monitoring system in accordance with the present invention.

FIG. 3C is the third schematic view of the second embodiment of the monitoring system in accordance with the present invention.

FIG. 3D is the fourth schematic view of the second embodiment of the monitoring system in accordance with the present invention.

FIG. 4A is the first schematic view of the third embodiment of the monitoring system in accordance with the present invention.

FIG. 4B is the second schematic view of the third embodiment of the monitoring system in accordance with the present invention.

FIG. 4C is the third schematic view of the third embodiment of the monitoring system in accordance with the present invention.

FIG. 5A is the first schematic view of the fourth embodiment of the monitoring system in accordance with the present invention.

FIG. 5B is the second schematic view of the fourth embodiment of the monitoring system in accordance with the present invention.

FIG. 5C is the third schematic view of the fourth embodiment of the monitoring system in accordance with the present invention.

FIG. 5D is the fourth schematic view of the fourth embodiment of the monitoring system in accordance with the present invention.

FIG. 6A is the first schematic view of the fifth embodiment of the monitoring system in accordance with the present invention.

FIG. 6B is the second schematic view of the fifth embodiment of the monitoring system in accordance with the present invention.

FIG. 6C is the third schematic view of the fifth embodiment of the monitoring system in accordance with the present invention.

FIG. 6D is the fourth schematic view of the fifth embodiment of the monitoring system in accordance with the present invention.

FIG. 7A is the first schematic view of the sixth embodiment of the monitoring system in accordance with the present invention.

FIG. 7B is the second schematic view of the sixth embodiment of the monitoring system in accordance with the present invention.

FIG. 8A is the first schematic view of the seventh embodiment of the monitoring system in accordance with the present invention.

FIG. 8B is the second schematic view of the seventh embodiment of the monitoring system in accordance with the present invention.

FIG. 9 is the flow chart of the control method for a monitoring system in accordance with the present invention.

### DETAILED DESCRIPTION OF THE PREFERRED EMBODIMENTS

The technical content of the present invention will become apparent by the detailed description of the following embodiments and the illustration of related drawings as follows.

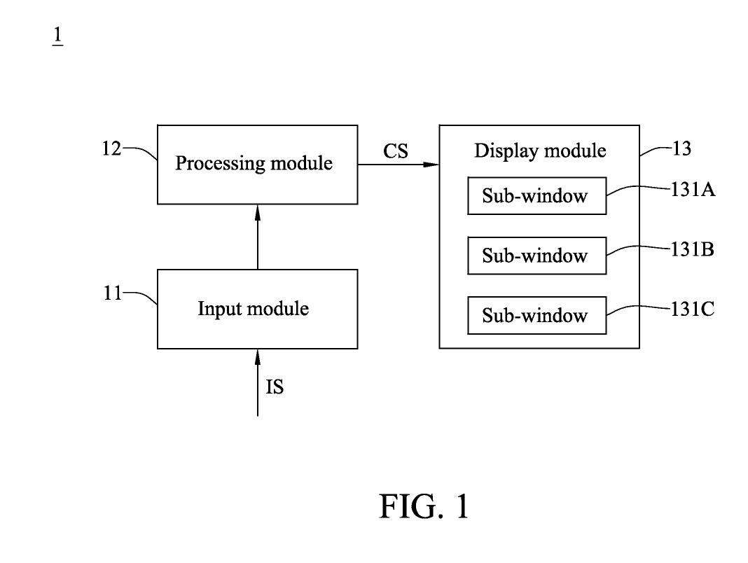

Please refer to FIG. 1, which is the block diagram of the monitoring system in accordance with the present invention. The monitoring system 1 may include a display module 13, an input module 11, and a processing module 12.

As shown in FIG. 1, the display module is operable to display a plurality of sub-windows 131; in a preferred embodiment, the display module 13 may be, for example, a liquid-crystal display and the like. The input module 11 may be operable to receive an input signal IS inputted by a user and generate a control signal CS according to the input signal IS; in a preferred embodiment, the input module 11 may be a pointer device, such as a mouse, or may be a touch device, such as a touch screen, etc. The processing module 12 is operable to receive the control signal CS to control any one of the sub-windows 131 of the display module 13 according to the control signal CS. Accordingly, the user can use the input module 11 to input the input signal IS to control the display module 13 via the process module 12; for example, the user may enlarge, minify, reshape, or move any one of the sub-windows 131A, 131B, and 131C to change its coverage.

For example, when the coverage of the sub-windows 131A is modified by the user, the processing module 12 may simultaneously execute a first recursive function to detect whether the sub-window 131A modified by the user overlaps any one of the other sub-windows 131B and 131C; if the sub-window 131A overlaps the other sub-window 131B, the processing module 12 may push the sub-window 131B or directly minify the sub-window 131A; the processing module 12 may keep executing the first recursive function until all of the sub-windows 131A, 131B, and 131C do not overlap.

If the sub-window 131A modified by the user fails to overlap any one of the other sub-windows 131B and 131C, the processing module 12 may execute a second recursive function to detect whether the original distance between the sub-windows 131A and sub-window 131B remains unchanged; if the original distance between the sub-window 131A and the sub-window 131B is changed, the processing module 12 may pull back the sub-window 131B; the processing module 12 may keep executing the second recursive function until the original distances between all sub-windows 131A, 131B, and 131C remain unchanged. In this way, the display module 12 can always display all of the sub-windows 131A, 131B, and 131C, so the user will never miss any important information.

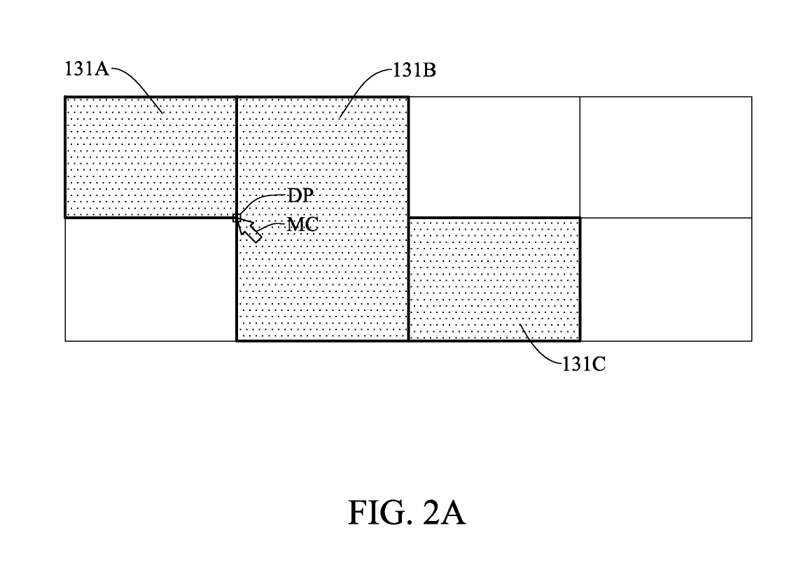

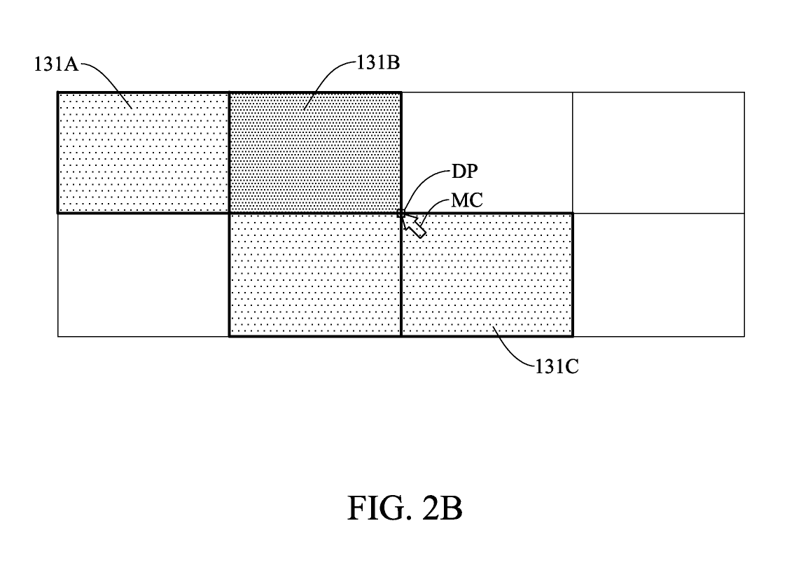

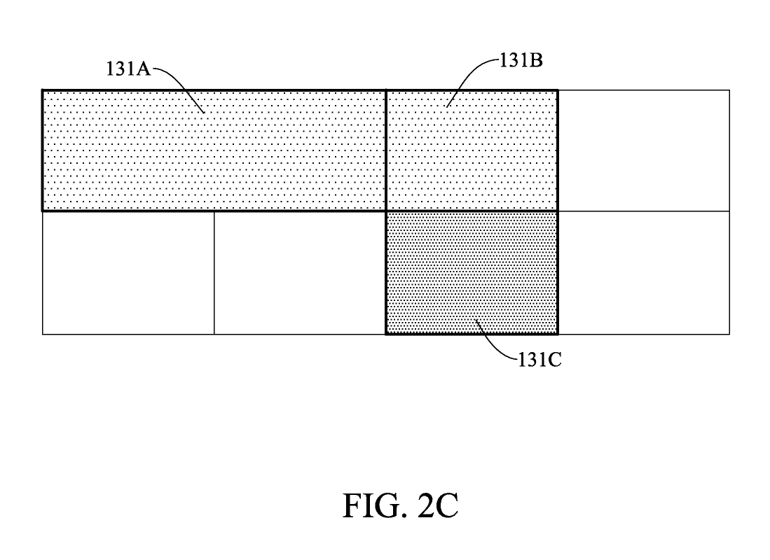

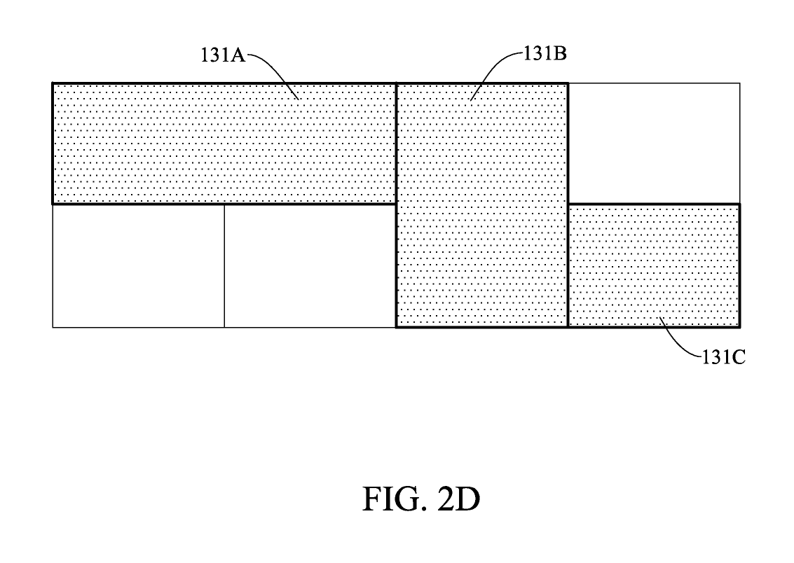

Please refer to FIG. 2A, FIG. 2B, FIG. 2C, and FIG. 2D, which are the first schematic view, second schematic view, third schematic view, and fourth schematic view of the first embodiment of the monitoring system in accordance with the present invention. The embodiment illustrates one of the preferred operation modes of the monitoring system according to the present invention. The user can use a pointer device, such as a mouse, to intuitively modify the coverage of any one of the sub-windows 131A, 131B, 131C, 131D, and 131E of the display module 13 by a simple drag-and-drop operation; for example, the user may enlarge, minify, reshape, or move any one of the sub-windows 131A, 131B, 131C, and 131D to change its coverage by the pointer device.

As shown in FIG. 2A, the user can move the mouse cursor MC to the drag point DP of the sub-window 131A to drag the drag point DP to another position of the display module 13 so as to enlarge the sub-window 131A; the drag point DP may be any one of the corners of the sub-window 131A or any one of the points on the edge of the sub-window 131A.

As shown in FIG. 2B, after the sub-window 131A is enlarged, the processing module may execute a first recursive function to detect whether the sub-window 131A overlaps the other sub-windows 131B and 131C. When detecting the sub-window 131A overlaps with the sub-window 131B, the processing module may push the sub-window 131B to the residual space of the display module 13, and then keep executing the first recursive function to detect whether the sub-window 131B overlaps the sub-window 131C. As shown in FIG. 2C, when detecting the sub-window 131B overlaps with the sub-window 131C, the processing module may push the sub-window 131C to the residual space of the display module 13. As shown in FIG. 2D, the processing module may keep executing the first recursive function until all sub-windows 131A, 131B, and 131C of the display module 13 do not overlap.

After the first recursive function ends, the processing module may execute a second recursive function to detect whether the original distance between the sub-windows 131A and 131B remains unchanged so as to keep the distances between the sub-windows 131A, 131B, and 131C the same with the original distances before the sub-window 131A is enlarged.

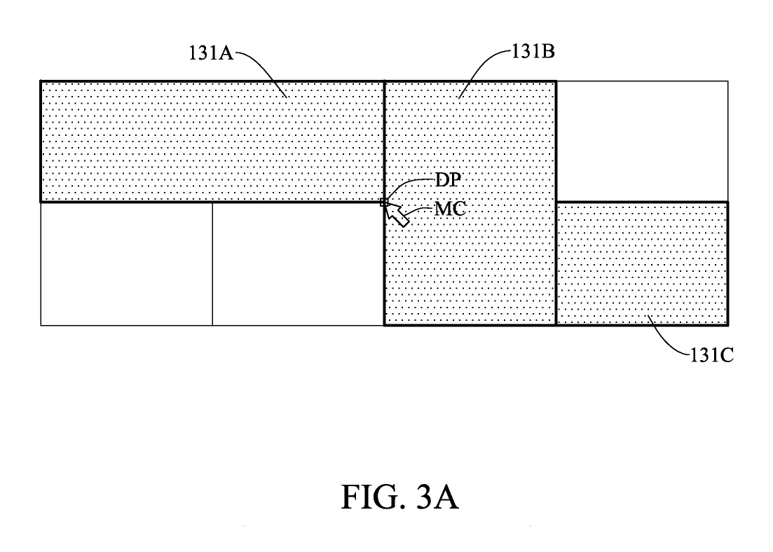

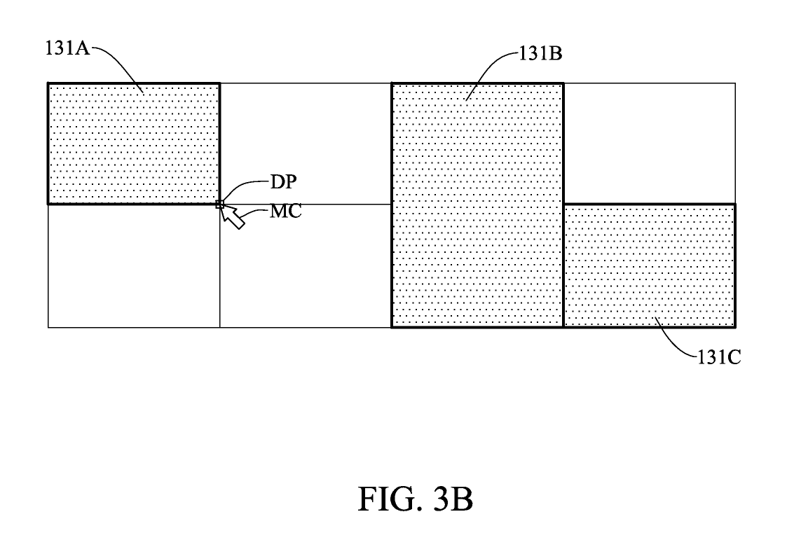

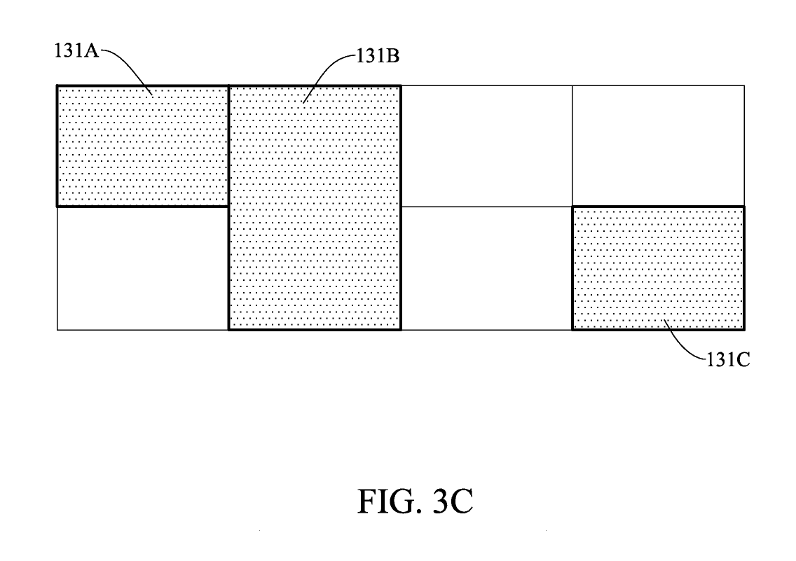

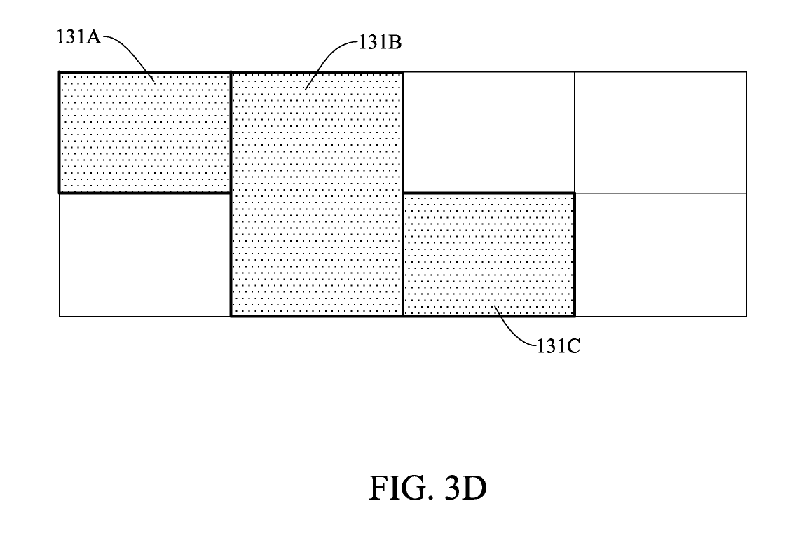

Please refer to FIG. 3A, FIG. 3B, FIG. 3C, and FIG. 3D, which are the first schematic view and, second schematic view, third schematic view, and fourth schematic view of the second embodiment of the monitoring system in accordance with the present invention. The embodiment illustrates one of the preferred operation modes of the monitoring system according to the present invention.

As shown in FIG. 3A, the user can move the mouse cursor MC to the drag point DP of the sub-window 131A to drag the drag point DP to another position of the display module 13 so as to minify the sub-window 131A.

As shown in FIG. 3B, after the sub-window 131A is minified, the processing module may execute a first recursive function to detect whether the sub-window 131A overlaps the other sub-windows 131 B and 131C. If detecting the sub-window 131A fails to overlap any one of the other sub-windows 131B and 131C, the processing module may execute a second recursive function to detect whether the original distance between the sub-window 131A and the sub-window 131B remains unchanged.

As shown in FIG. 3B, when detecting the original distance between the sub-window 131A and the sub-window 131B changes, the processing module may pull back the sub-window B to keep the distance between the sub-window 131A and sub-window 131B the same with the original distance before the sub-window 131A is minified.

Next, as shown in FIG. 3C, the processing module may keep executing the second recursive function to detect whether the original distance between the sub-window 131B and the sub-window 131C remains unchanged. When detecting the original distance between the sub-window 131B and the sub-window 131C changes, the processing module may pull back the sub-window 131C to keep the distance between the sub-window 131B and sub-window 131C the same with the original distance before the sub-window 131A is minified.

As shown in FIG. 3D, the processing module may keep executing the second recursive function until the original distances between all sub-windows 131A, 131B, and 131C of the display module 13 remain unchanged.

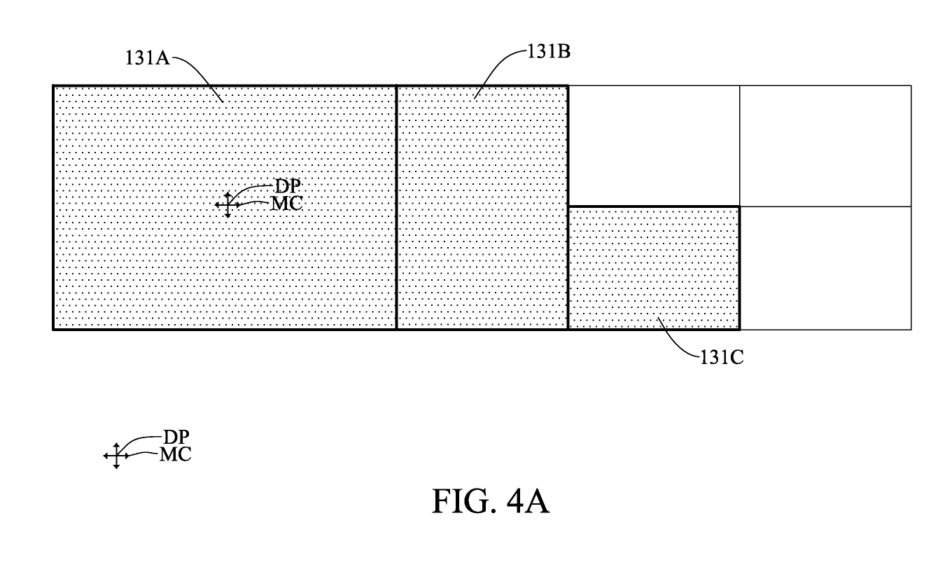

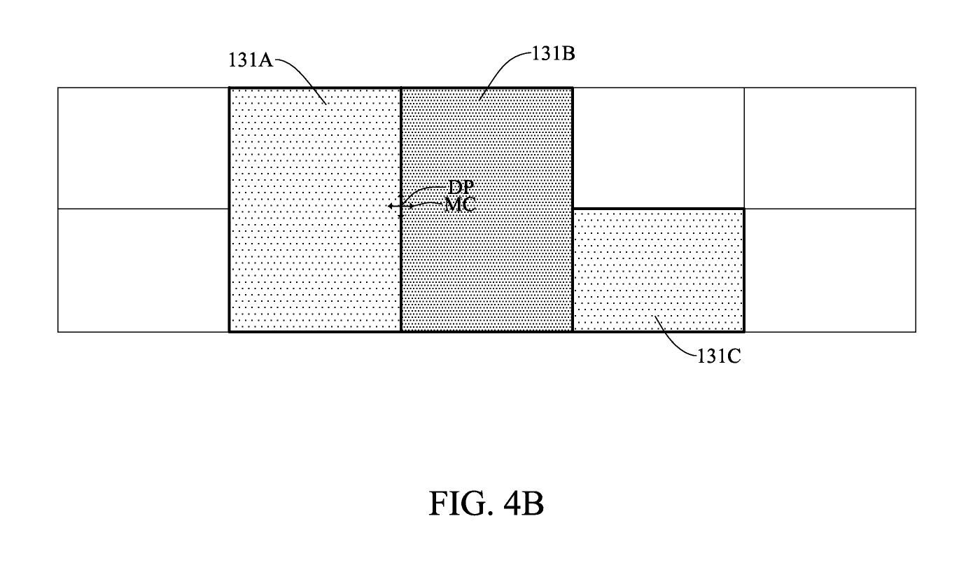

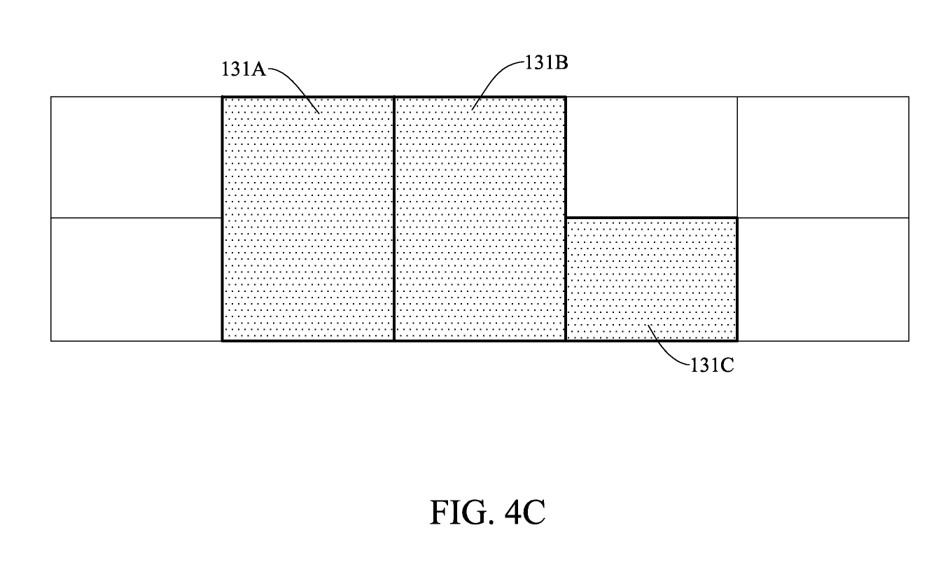

Please refer to FIG. 4A, FIG. 4B, and FIG. 4C, which are the first schematic view, second schematic view, and third schematic view of the third embodiment of the monitoring system in accordance with the present invention. The embodiment illustrates one of the preferred operation modes of the monitoring system according to the present invention.

As shown in FIG. 4A, the user can move the mouse cursor MC to the drag point DP of the sub-window 131A to drag the drag point DP to another position of the display module 13 so as to move the sub-window 131A to the position between the sub-window B and sub-window C, and then the coverage of the sub-window 131A may be adjusted according to the residual space of the display module 13; the drag point DP may be any point of the sub-window A.

As shown in FIG. 4B, after the sub-window 131A is moved to overlap the sub-window 131B, the processing module may automatically calculate the proper length and width of the sub-window 131A according to the residual space of the display module 13 to adjust its coverage. As shown in FIG. 4C, the processing module may minify the moved sub-window 131A to make it have proper length and width so as to avoid overlapping the sub-window 131B, so the user can always see all of the sub-windows 131A, 131B, and 131C even if the sub-window 131A is moved by the user and the sub-window 131A can have the most appropriate size.

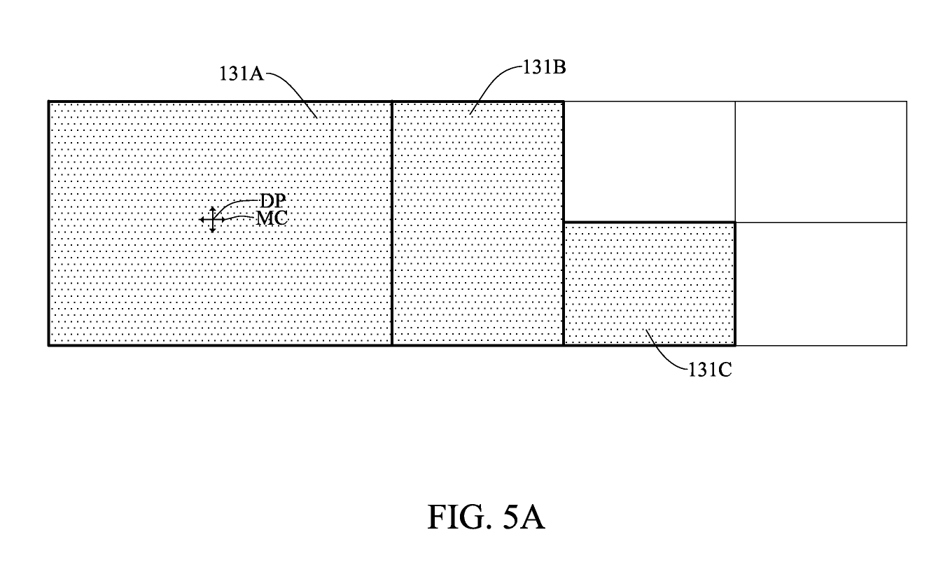

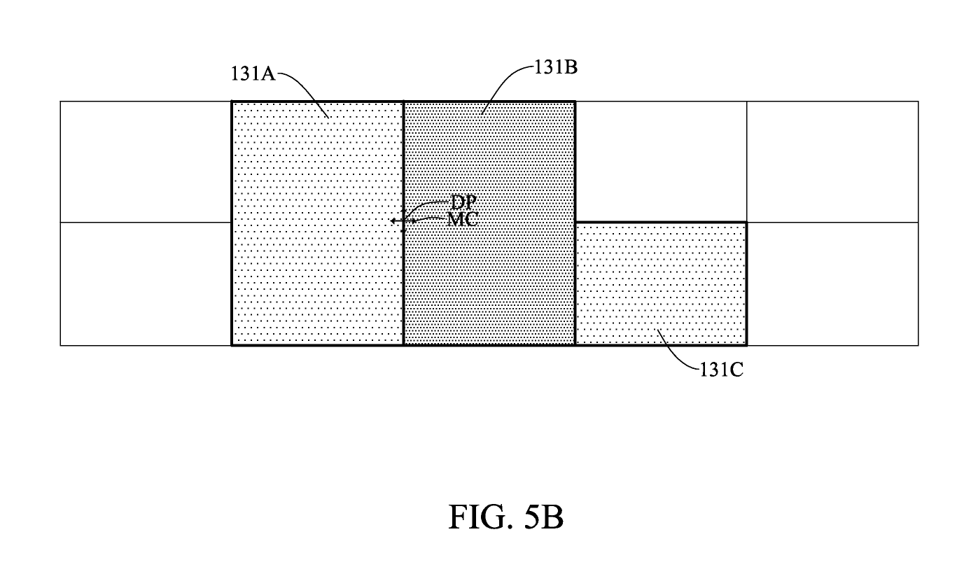

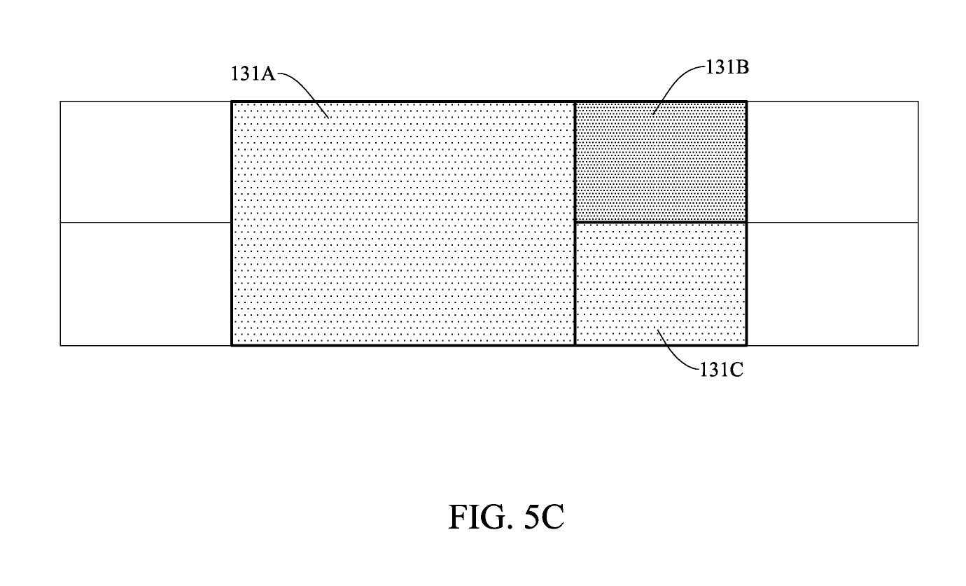

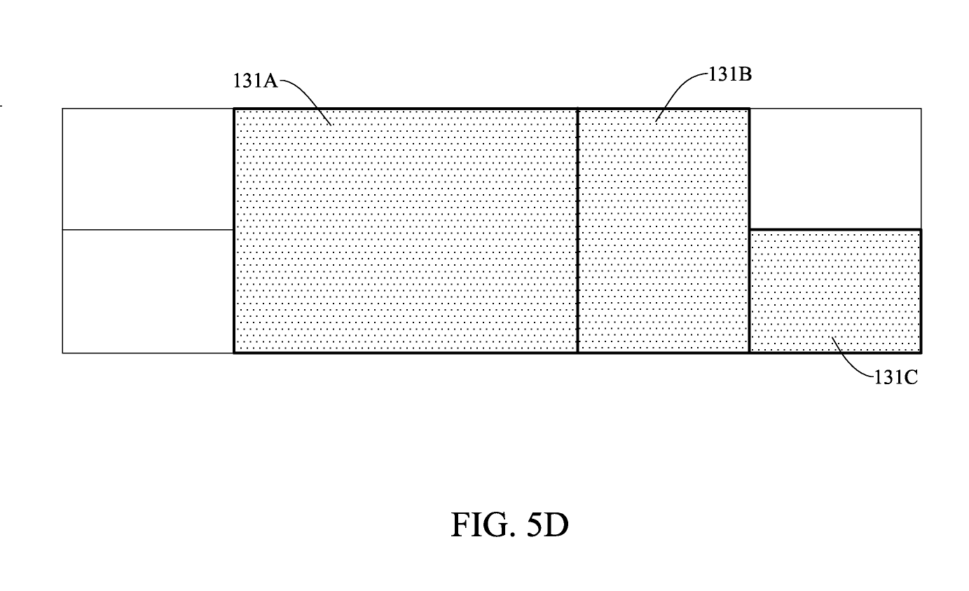

Please refer to FIG. 5A, FIG. 5B, FIG. 5C, and FIG. 5D, which are the first schematic view, the second schematic view, the third schematic view, and the fourth schematic view of the fourth embodiment of the monitoring system in accordance with the present invention. The embodiment illustrates one of the preferred operation modes of the monitoring system according to the present invention.

In the embodiment, the user can move one of the sub-windows to another position but the size of the moved sub-window may remain unchanged. As shown in FIG. 5A, the user can move the mouse cursor MC to the drag point DP of the sub-window 131A to drag the drag point DP to another position of the display module 13 so as to move the sub-window 131A. As shown in FIG. 5B, after the sub-window 131A is moved, the processing module may execute a first recursive function to detect whether the sub-window 131A overlaps the other sub-windows 131B and 131C. When detecting the sub-window 131A overlaps with the sub-window 131B, the processing module may push the sub-window 131B to the residual space of the display module 13, and then keep executing the first recursive function to detect whether the sub-window 131B overlaps the sub-window 131C.

As shown in FIG. 5C, when detecting the sub-window 131B overlaps with the sub-window 131C, the processing module may push the sub-window 131C to the residual space of the display module 13. As shown in FIG. 5D, the processing module may keep executing the first recursive function until all sub-windows 131A, 131B, and 131C do not overlap.

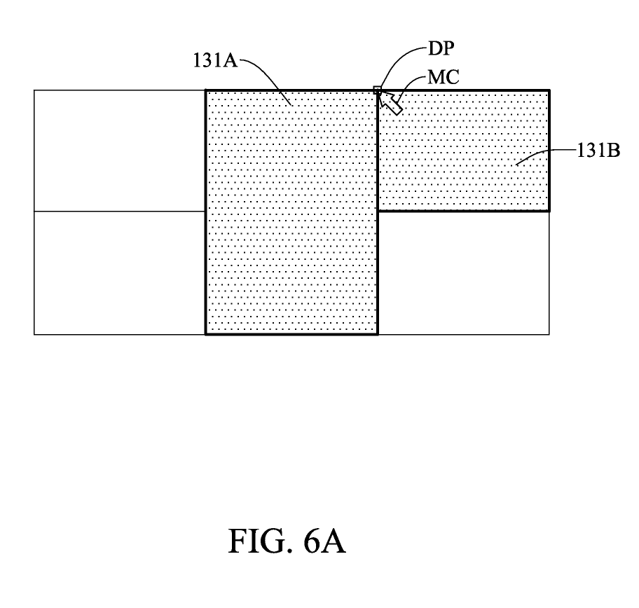

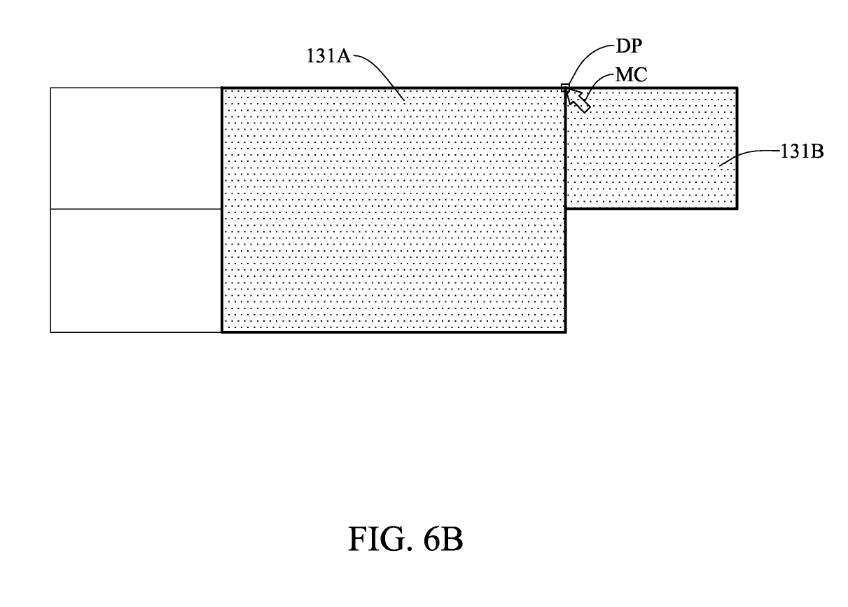

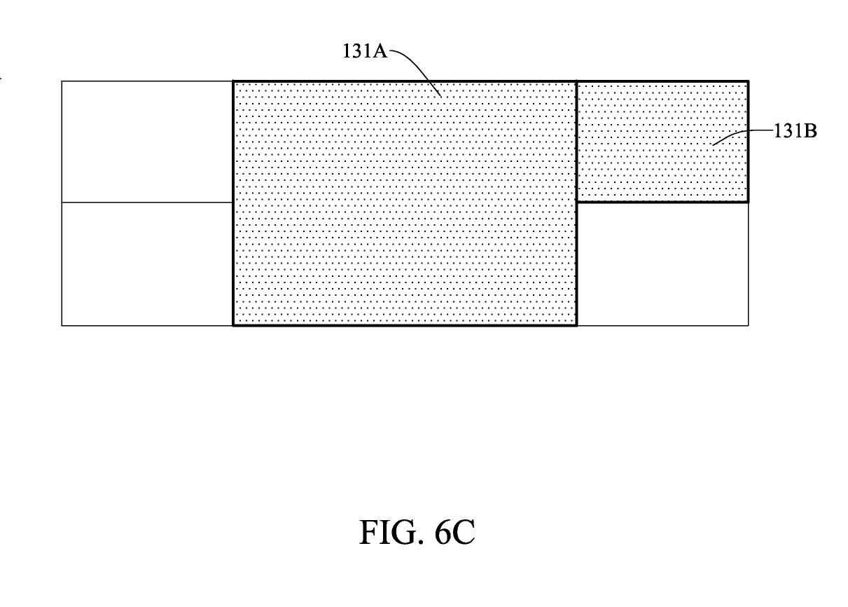

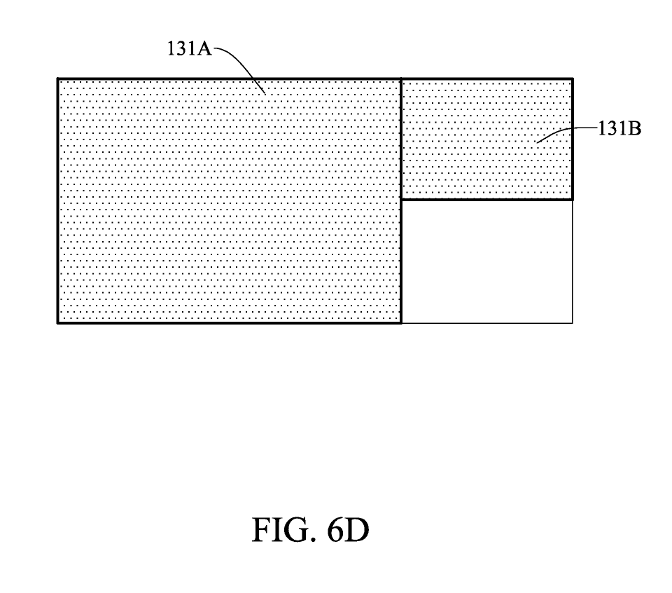

Please refer to FIG. 6A, FIG. 6B, FIG. 6C, and FIG. 6D, which are the first schematic view, the second schematic view, the third schematic view, and the fourth schematic view of the fifth embodiment of the monitoring system in accordance with the present invention. The embodiment illustrates one of the preferred operation modes of the monitoring system according to the present invention.

In the embodiment, after executing the first recursive function and/or the second recursive function, the processing module may further execute a first optimization function to optimize the arrangement of all sub-windows 131A and 131B of the display module 13. As shown in FIG. 6A, the user can move the mouse cursor MC to the drag point DP of the sub-window 131A to drag the drag point DP to another position of the display module 13 so as to enlarge the sub-window 131A.

As shown in FIG. 6B, after the sub-window 131A is enlarged, the processing module may execute the first recursive function to push the sub-window 131B overlapping the enlarged sub-window 131A.

Simultaneously, the processing module may detect whether the columns and the rows of the display module 13 are enough for all of the sub-windows 131A and 131B. As shown in FIG. 6C, when detecting the columns and/or the rows are not enough for all of the sub-windows 131A and 131B, the processing module may increase the columns and/or the rows until they are enough for all of the sub-windows 131A and 131B.

After the first optimization function ends, the processing module may further execute a second optimization function to further optimize the arrangement of all of the sub-windows 131A and 131B of the display module 13, wherein the processing module may detect whether each of columns and rows of the display module includes any one of the sub-windows 131A and 131B. As shown in FIG. 6D, when detecting some columns and rows of the display module 13 do not include any one of the sub-windows 131A and 131B, the processing module may delete them.

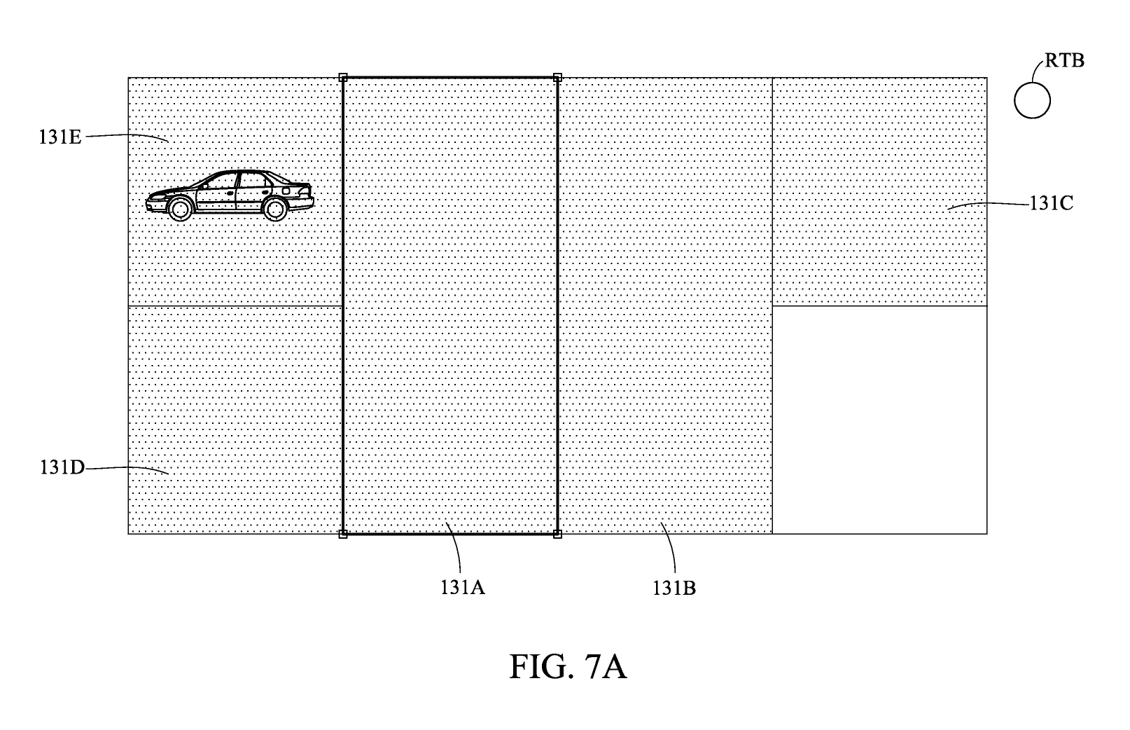

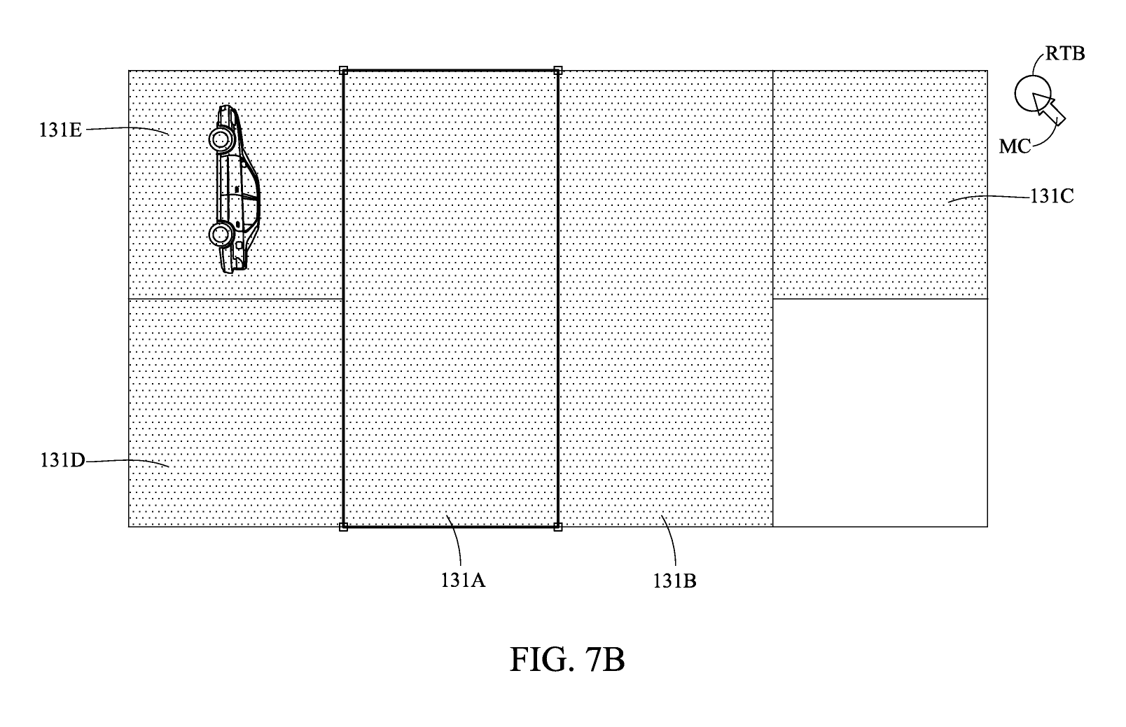

Please refer to FIG. 7A and FIG. 7B, which are the first schematic view and second schematic view of the sixth embodiment of the monitoring system in accordance with the present invention. The embodiment illustrates one of the preferred operation modes of the monitoring system according to the present invention.

In the embodiment, the monitoring system can further provide the rotation function for the user to conveniently rotate any one of the sub-windows 131A, 131B, 131C, 131D, and 131E to the desire angle. As shown in FIG. 7A, the monitoring system can provide a rotation button RTB on the display module 13.

As shown in FIG. 7B, after the user clicks the rotation button RTB, the processing module will rotate the sub-window 131E 90 degrees clockwise. Similarly, the user can rotate the other sub-windows 131A, 131B, 131C, and 131D by the same operation. In this way, the user can rotate the image of any one of the sub-windows 131A, 131B, 131C, 131D, and 131E by only one click without changing the settings of the cameras, which is very convenient in use. Besides, the user can rotate the image of any one of the sub-windows 131A, 131B, 131C, 131D, and 131E by any angle and the ratio of the length to the width of the rotated sub-window will remain unchanged.

It is worthy to note that if the user wants to see more details of one of the sub-windows of the conventional monitoring system, the user should enlarge this sub-window. However, after the sub-window is enlarged, the other sub-windows may be covered by the enlarged sub-window; as a result, the user may miss some important information because the user cannot always see all of the sub-windows. On the contrary, in one embodiment of the present invention, the monitoring system not only can automatically adjust the other sub-windows after one of the sub-windows is enlarged, but also can move these sub-windows to the proper positions to prevent these sub-windows from being covered by the enlarged sub-window. Accordingly, the user will never miss any important information, so the monitoring system according to the present invention can achieve higher security.

On the other hand, the conventional monitoring system only provides several fixed modes to display the sub-windows, so the user cannot adjust the size and the position of the sub-windows at will, which is not flexible in use. On the contrary, in one embodiment of the present invention, the user can adjust the coverage of the any one of the sub-windows at will or move any one of the sub-windows to any position of the display module. Therefore, the monitoring system according to the present invention will not be limited to several fixed modes, which is more flexible in use.

In addition, the conventional monitoring system is very hard to operate because the user should click various icons on the screen of the monitoring system to perform the functions which the user wants to execute. Thus, the conventional monitoring fails to provide a user-friendly operation interface. On the contrary, in one embodiment of the present invention, the user can intuitively adjust or move any one of the sub-windows of the monitoring system only by a simple drag-and-drop operation rather than a complicated operation interface, and then the monitoring system will automatically rearrange the other sub-windows according to the residual space of the display module 13. Therefore, the monitoring system according to the present invention provides a user-friendly operation interface. Obviously, the present invention definitely has an inventive step.

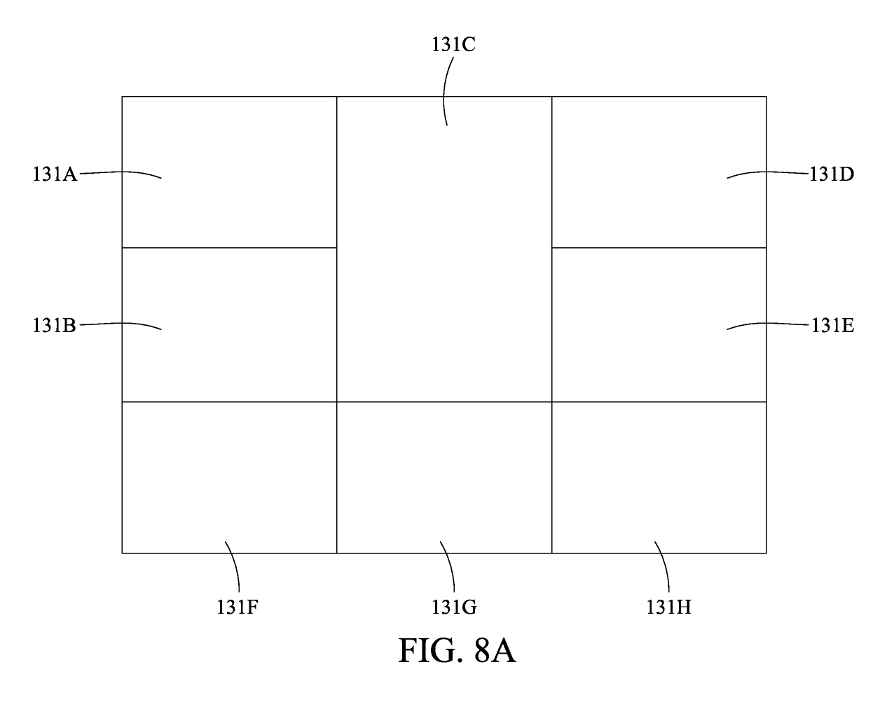

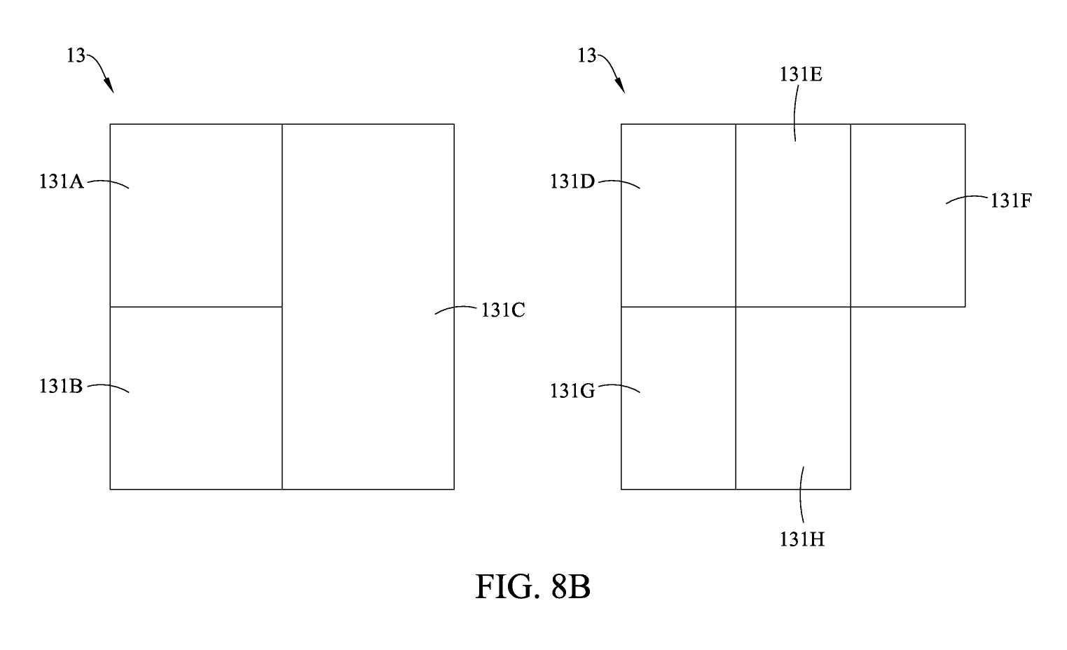

Please refer to FIG. 8A and FIG. 8B, which are the first schematic view and second schematic view of the seventh embodiment of the monitoring system in accordance with the present invention. The embodiment illustrates one of the preferred operation modes of the monitoring system according to the present invention.

FIG. 8A shows the arrangement of the sub-windows 131A, 131B, 131C, 131D, 131E, 131F, 131G, and 131H displayed on the display module 13 when the monitoring system has only one display module 13.

As shown in FIG. 8B, when the monitoring system is connected to two display modules 13, the processing module will automatically allocate the sub-windows 131A, 131B, 131C, 131D, 131E, 131F, 131G, and 131H to all of the display modules 13. Besides, the original ratio of each of the sub-windows 131A, 131B, 131C, 131D, 131E, 131F, 131G, and 131H can remain unchanged, which is very convenient in use.

It is worthy to note that when the conventional monitoring system is connected to two or more displays, the user should readjust the setting of the conventional monitoring system in order to allocate these sub-windows to the displays, which is very inconvenient in use. On the contrary, in the embodiment, the processing module will automatically allocate the sub-windows to all of the display modules after the monitoring system is connected to two or more display modules, so the user does not need to readjust the setting of the conventional monitoring system, which is very convenient in use.

Although the above description about the monitoring system in accordance with the present invention has illustrated the concept of the control method for a monitoring system in accordance with the present invention, the following still provides a flow chart to specify the control method for a monitoring system in accordance with the present invention.

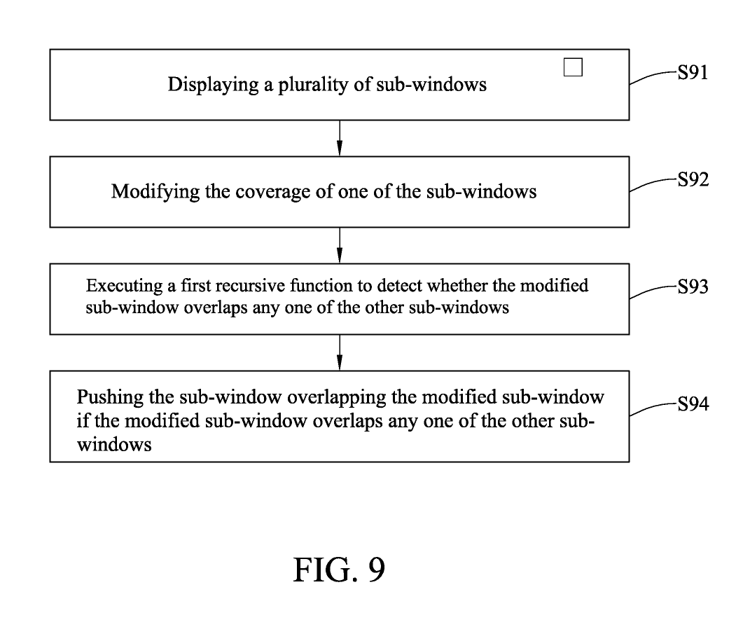

Please refer to FIG. 9, which is the flow chart of the control method for a monitoring system in accordance with the present invention; the method may include the following steps:

In the step S91: displaying a plurality of sub-windows.

In the step S92: modifying the coverage of one of the sub-windows.

In the step S93: executing a first recursive function to detect whether the modified sub-window overlaps any one of the other sub-windows.

In the step S94: pushing the sub-window overlapping the modified sub-window if the modified sub-window overlaps any one of the other sub-windows.

The detailed description and the exemplary embodiments of the control method for a monitoring system in accordance with the present invention have been described in the description of the monitoring system in accordance with the present invention; therefore, they will not be repeated herein again.

In summation of the description above, the monitoring system, according to one embodiment of the present invention, can automatically adjust the other sub-windows according to the residual space of the display module to take full advantage of the residual space of the display module and move these sub-windows to the proper positions to prevent these sub-windows from being covered by the enlarged, minified, or reshaped sub-window. Therefore, the monitoring system according to the present invention can achieve higher security.

Also, according to one embodiment of the present invention, the user can adjust the sub-windows of the monitoring system by an intuitive drag-and-drop operation instead of complicated operation interface. Thus, the monitoring system according to the present invention can provide a more user-friendly operation interface.

Besides, according to one embodiment of the present invention, the user can resize any one of the sub-windows at will or move any one of the sub-windows to any position of the display module. Therefore, the monitoring system according to the present invention is more flexible in use.

Further, according to one embodiment of the present invention, the user can resize or move any one of the sub-windows only by a simple drag-and-drop operation. Therefore, the monitoring system according to the present invention provides a user-friendly operation interface.

Moreover, according to one embodiment of the present invention, the processing module will automatically allocate the sub-windows to all of the display modules if the monitoring system has two or more display modules; accordingly, the user does not need to readjust the setting of the monitoring system. Therefore, the monitoring system according to the present invention is more convenient in use.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A monitoring system, comprising:
a display module, operable to display a plurality of sub-windows;
an input module, operable to receive an input signal inputted by a user and generate a control signal according to the input signal; and
a processing module, operable to receive the control signal to control any one of the sub-windows of the display module according to the control signal;
wherein when a coverage of any one of the sub-windows is modified by the user, the processing module will execute a first recursive function to detect whether the modified sub-window overlaps any one of the other sub-windows; if the modified sub-window overlaps any one of the other sub-windows, the processing module pushes the sub-window overlapping the modified sub-window to a residual space of the display module.

2. The monitoring system of claim 1, wherein the processing module keeps executing the first recursive function until all of the sub-windows do not overlap.

3. The monitoring system of claim 1, wherein if the modified sub-window fails to overlap any one of the other sub-windows, the processing module executes a second recursive function to detect whether original distances between the modified sub-window and the sub-windows in the vicinity of the modified sub-window remains unchanged.

4. The monitoring system of claim 3, wherein if the original distances are changed, the processing module pulls back the sub-windows in the vicinity of the modified sub-window.

5. The monitoring system of claim 4, wherein the processing module keeps executing the second recursive function until the original distances between all of the sub-windows remain unchanged.

6. The monitoring system of claim 5, wherein the processing module further executes an first optimization function to detect whether columns and rows of the display module are enough for all of the sub-windows after the second recursive function ends, and then the processing module increases the columns and/or the rows until the columns and the rows are enough for all of the sub-windows.

7. The monitoring system of claim 6, wherein the processing module further executes a second optimization function to detect whether each of columns and rows of the display module includes any one of the sub-windows after the first optimization function ends, and then the processing module deletes the columns and/or the rows not occupied by any one of the sub-windows.

8. The monitoring system of claim 1, wherein when the monitoring system has two or more display modules, the processing module automatically allocates the sub-windows to all of the display modules.

9. The monitoring system of claim 1, wherein the processing module is able to rotate an image of any one of the sub-windows according to the control signal but keeps a ratio of a length and a width of the sub-window rotated unchanged.

10. The monitoring system of claim 1, wherein the processing module is able to rearrange the sub-windows according to the control signal; the processing module changes the coverages of the sub-windows to minimize the residual space of the display module, and a ratio between the sub-windows remains unchanged after the processing module rearranges the sub-windows.

11. A control method for a monitoring system, comprising the following steps:
displaying a plurality of sub-windows;
modifying a coverage of one of the sub-windows;
executing a first recursive function to detect whether the modified sub-window overlaps any one of the other sub-windows; and
pushing the sub-window overlapping the modified sub-window if the modified sub-window overlaps any one of the other sub-windows.

12. The control method of claim 11, further comprising the following steps:
keeping executing the first recursive function until all of the sub-windows do not overlap.

13. The control method of claim 11, further comprising the following steps:
executing a second recursive function to detect whether original distances between the modified sub-window and the sub-windows in the vicinity of the modified sub-window remains unchanged if the modified sub-window fails to overlap any one of the other sub-windows.

14. The control method of claim 13, further comprising the following step:
pulling back the sub-windows in the vicinity of the modified sub-window if the original distances are changed.

15. The control method of claim 14, further comprising the following step:
keeping executing the second recursive function until the original distances between all sub-windows remain unchanged.

16. The control method of claim 15, further comprising the following step:
executing a first optimization function to detect whether columns and rows of the display module are enough for all of the sub-windows after the second recursive function ends, and increasing the columns and/or the rows until the columns and the rows are enough for all of the sub-windows.

17. The control method of claim 16, further comprising the following step:
executing a second optimization function to detect whether each of columns and rows of the display module not occupied by any one of the sub-windows after the first optimization function ends, and deleting the columns and rows not occupied by any one of the sub-windows.

18. The control method of claim 11, further comprising the following step:
automatically allocating the sub-windows to all of the display modules when the monitoring system has two or more display modules.

19. The control method of claim 11, further comprising the following step:
rotating an image of any one of the sub-windows and keeping a ratio of a length to a width of the sub-window unchanged.

20. The control method of claim 11, further comprising the following step:
rearranging the sub-windows, and keeping a ratio between the sub-windows unchanged and changing the coverages of the sub-windows to minimize the residual space of the display module after these sub-windows are rearranged.
